(19) United States
(12) Patent Application Publication
(10) Pub. No.: US 2008/0268923 A1
(43) Pub. Date: Oct. 30, 2008

(54) Folding Rotary Portable Terminal

(75) Inventors: Kenichi Mochizuki, Kanagawa (JP); Hidehiro Yanagibashi, Kanagawa (JP); Kazunori Satou, Kanagawa (JP); Akira Hasegawa, Tokyo (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/572,610

(22) PCT Filed: Aug. 2, 2005
(86) PCT No.: PCT/JP05/14489

§ 371 Date: Jan. 24, 2007

(30) Foreign Application Priority Data
Aug. 2, 2004 (JP) 2004-225377

(51) Int. Cl. H04M 1/00

(52) U.S. Cl. 455/575.3

(57) ABSTRACT

In a folding rotary portable terminal, a first case having a display section for at least displaying information and side face keys and are coupled to a second case having at least a camera section and side face keys and through a hinge part having at least two degrees of freedom in rotation, namely open/close and orthogonal directions. When the first case is rotated by 180° about the rotary shaft of the hinge part from an opened state of the first case and the second case to a folding state where the first case is superposed on the second case with the display section directed outward, the side face keys on the different side faces of the first case and the second case come to the same side. Thus, even in the folding state, various functions can be operated easily.

### TECHNICAL FIELD

The present invention relates to a folding rotary portable terminal with a camera.

### BACKGROUND ART

Recently, a portable terminal such as a portable phone includes many functions such as camera, television (TV), and navigation functions, in addition to an Internet function. Especially, the camera function has become a standard function. Enlarging the display section and a function equivalent to a digital camera has been demanded, while downsizing the case has been demanded.

In a conventional folding rotary portable terminal with a camera, a first case constituting the terminal is made not only foldable with respect to a second case, but also rotatable so that the first case is turned upside down from an opened state and is superposed on the second case. Even in the resultant state, photographing with the camera is allowed. For example, in a folding portable terminal having a lens on the outer face of the first case, when the first case is rotated by 180° from a state where the first case and the second case are opened to a folding state where the first case is superposed on the second case, the display section of the first case directs outward. This state shows an appearance similar to a general digital camera. For example, Japanese Patent Unexamined Publication No. 2003-125049 discloses a folding rotary portable terminal where a shutter key is disposed at a position such as a side face or the hinge section at which the key is exposed to the outside in the folding state. A user can support the portable terminal with both hands, and can photograph a subject while making the subject displayed on the liquid crystal screen, similarly to photographing with a digital camera.

Japanese Patent Unexamined Publication No. 2003-309634 discloses a folding rotary portable terminal where a plurality of side face keys are disposed adjacently to the display section of the first case correspondingly to many functions. A plurality of functions such as navigation, game, and TV functions, as well as a photographing function, can be operated in a folding state where the first case is superposed on the second case with the display section directed outward.

In the conventional portable terminal disclosed in Japanese Patent Unexamined Publication No. 2003-125049, however, the area of the display section is maximized, and no key is disposed on the face having the display section. When photographing is performed in the folding state where the display section is directed outward, therefore, only the shutter key is disposed on the surface of the portable terminal. Functions similar to those of the so-called digital camera, such as photographing mode selection and zoom, cannot be operated during photographing with camera.

In the conventional portable terminal disclosed in Japanese Patent Unexamined Publication No. 2003-309634, since a plurality of operation keys are disposed adjacently to the display section, various operations can be performed in the folding state where the display section is directed outward. However, the area of the display section is small.

Therefore, while a portable terminal having navigation, TV, and game functions is widely used, the area of the display section must be increased and various functions must be attained without enlarging the cases.

### SUMMARY OF THE INVENTION

The present invention addresses the above-mentioned problems, and provides a folding rotary portable terminal with a camera where keys are disposed on different side faces of the different cases. Thus, the number of side face keys operable in a folding state can be increased and the size of the display section can be made sufficiently large without enlarging the cases, and various functions can be operated in any state. Especially, the present invention provides a folding rotary portable terminal with a camera in which various functions can be easily operated with side face keys in a folding state where the display section is directed outward.

In a folding rotary portable terminal of the present invention, a first case having a display section for at least displaying information and a second case having at least a camera section are inter-coupled through a hinge part having at least two degrees of freedom in rotation, namely the open/close direction and the orthogonal direction. At least one side face key is disposed on different side faces of the first case and the second case.

Thanks to this structure, many side face keys of which sizes are sufficiently large can be arranged comparing with a structure where side face keys are arranged one side face. Therefore, various operations are allowed even in the folding state. Since the side face keys have a size suitable for the touch, the side face keys arranged on each case can be easily operated even with the thumb in an opened state of the portable terminal.

In a folding rotary portable terminal of the present invention, a first case having a display section for at least displaying information and a second case having at least a camera section are inter-coupled through a hinge part having at least two degrees of freedom in rotation, namely the open/close direction and the orthogonal direction. When the first case is rotated by 180° about the rotary shaft of the hinge part from an opened state to a folding state, side face keys arranged on the different side faces of the first case and the second case come to the same side. Here, in the opened state, the first case and the second case are opened, and, in the folding state, the first case is superposed on the second case with the display section of the first case directed outward.

Thanks to this structure, side face keys on the different side faces of the first case and the second case are directed to the same direction in the folding state where the first case is superposed on the second case with the display section of the first case directed outward. Here, the folding state is brought by rotating the first case by 180° about the rotary shaft of the hinge part from the opened state of the first case and second case. Therefore, during photographing with camera, a user can easily operate each side face key while supporting the cases sideways with both hands. Since the side face keys are positioned on the same side, the portable terminal can be handled with one hand.

In a folding rotary portable terminal of the present invention, a first case having a display section for at least displaying information and a second case having at least a camera section are inter-coupled through a hinge part having at least two degrees of freedom in rotation, namely the open/close direction and the orthogonal direction. When the first case is rotated by 180° about the rotary shaft of the hinge part from an opened state to a folding state, side face keys arranged on different side faces of the first case and the second case come to the top face. Here, the top face has a shutter key, and the folding state means that the first case is superposed on the second case with the display section of the first case directed outward.

Thanks to this structure, when a user holds the portable terminal with the shutter key directed upward in order to photograph a subject with the camera, the other side face keys are also directed upward and hence the user can easily operate various camera functions.

In a folding rotary portable terminal of the present invention, when the first case is rotated by 180° about the rotary shaft of the hinge part from an opened state to a folding state, side face keys on the first case and side face keys on the second case come to alternate positions. Here, in the folding state, the first case is superposed on the second case with the display section of the first case directed outward.

Thanks to this structure, in the folding state where the display section of the first case is directed outward, operating error and input error of the side face keys are prevented and the operability is improved.

In a folding rotary portable terminal of the present invention, when the first case is rotated by 180° about the rotary shaft of the hinge part from an opened state to a folding state, side face keys on the first case and side face keys on the second case overlap each other. Here, in the folding state, the first case is superposed on the second case with the display section of the first case directed outward.

Thanks to this structure, in the folding state where the display section of the first case is directed outward, two side face keys can be pushed simultaneously. Therefore, when one side face key must be pushed at a plurality of times in order to select an operation mode or a function, the simultaneous push of two side face keys can reduce the number of operations or widen the variety of operations.

In a folding rotary portable terminal of the present invention, an operation mode selection key is arranged on a side face of one of two cases, and an operation mode to be operated is selected from at least two operation modes.

Thanks to this structure, in the folding state where the display section of the first case is directed outward, many functions such as photographing with camera, TV, navigation, and game are selected.

In a folding rotary portable terminal of the present invention, a shutter key, a zoom key, a photo light key, a macro switch key, and a night mode switch key are disposed as the side face keys on side faces of two cases, and are operated during photographing with camera.

Thanks to this structure, even in the folding state where the display section of the first case is directed outward, many functions can be operated during photographing with camera, similarly to a standalone digital camera.

In a folding rotary portable terminal of the present invention, at least two channel switch keys are disposed as the side face keys arranged on side faces of two cases, and are operated during watching TV.

Thanks to this structure, even in the folding state where the display section of the first case is directed outward, watching TV is allowed with an operation similarly to that of a standalone TV.

In a folding rotary portable terminal of the present invention, as the side face keys arranged on side faces of two cases, a key for scrolling up and down the display section is disposed on one side face, and a key for scrolling it left and right is disposed on the other side face. The keys are operated during operating a specific function.

Thanks to this structure, in the folding state where the display section of the first case is directed outward, a user can easily scroll a screen, pointer, or the like on the display section up and down, and left and right with one hand.

In a folding rotary portable terminal of the present invention, a memo/manner mode switch key is disposed on a side face of one of two cases, and is used to switch between the memo function of voice memo or the like and the manner mode function.

Thanks to this structure, the memo function or manner mode function can be selectively set in any state of the portable terminal.

In a folding rotary portable terminal of the present invention, a clear key is disposed on a side face of one of two cases, and is used to return from the present operation state to the last state or to delete a set value.

Thanks to this structure, in the folding state where the display section of the first case is directed outward, various functions can be easily re-operated.

In the present invention, since the side face keys are disposed on different side faces of the first case and second case, the size of the display section can be made sufficiently large and the number of keys operable in the folding state can be increased. Therefore, the operations do not become complicated even in the folding state, and various functions can be operated though the portable terminal is compact.

When all the side face keys are arranged on the same side in the folding state where the first case is superposed on the second case with the display section of the first case directed outward, functions similar to those of a standalone digital camera can be operated during photographing with camera. Since the display section is large and various functions can be operated in this state, the operability of the multimedia function can be improved.

In the present invention, when the side face keys are disposed on different side faces, the sizes of the keys can be made suitable. Therefore, even when a user intends to operate a side face key with his/her thumb, the user can certainly perform the operation without accidentally pushing two keys. Therefore, since the side face key can be operated with the thumb even in the opened state of the portable terminal, the operability can be improved by using the side face key as an auxiliary key of the operation section during writing a mail or watching the Internet.

In the folding rotary portable terminal of the present invention, the side face keys arranged on different side faces of the first case and second case are directed in the same direction in the folding state. Here, in the folding state, the first case is superposed on the second case with the display section of the first case directed outward. When a side face key on each case is easily operated with the right or left forefinger, the portable terminal can be operated by one hand or in a sideways state of the cases similarly to the camera, and its operability becomes high.

In the folding rotary portable terminal having many functions of the present invention, the operability is high in any of an opened state of the cases, a folded state, and a folding state where the first case is superposed on the second case with the display section of the first case directed outward.

### BRIEF DESCRIPTION OF DRAWINGS

FIG. 1A is an outward appearance of a folded state of a folding rotary portable terminal in accordance with exemplary embodiment 1 of the present invention.

FIG. 1B is an outward appearance of an opened state of the folding rotary portable terminal in accordance with exemplary embodiment 1.

FIG. 1C is a perspective view of a folding state where a first case is superposed on a second case with a display section of the first case directed outward, in the folding rotary portable terminal in accordance with exemplary embodiment 1.

FIG. 2A is an appearance perspective view from the diagonally forward right side of a folded state of a folding rotary portable terminal in accordance with exemplary embodiment 2 of the present invention.

FIG. 2B is an appearance perspective view from the diagonally forward left side of the folded state of the folding rotary portable terminal in accordance with exemplary embodiment 2.

FIG. 3A is an outward appearance of an opened state of the folding rotary portable terminal in accordance with exemplary embodiment 2.

FIG. 3B is a rear outward appearance of the opened state of the folding rotary portable terminal in accordance with exemplary embodiment 2.

FIG. 4A is an outward appearance of a folding state where a first case is superposed on a second case with a display section of the first case directed outward, in the folding rotary portable terminal in accordance with exemplary embodiment 2.

FIG. 4B is a plan view of the folding state where the first case is superposed on the second case with the display section of the first case directed outward, in the folding rotary portable terminal in accordance with exemplary embodiment 2.

FIG. 5A is a side view of a side face key in selecting photographing mode in accordance with exemplary embodiment 2.

FIG. 5B is a side view of a side face key in selecting TV watching mode in accordance with exemplary embodiment 2.

FIG. 5C is a side view of a side face key in selecting navigation mode in accordance with exemplary embodiment 2.

FIG. 6A is an outward appearance of a folding state where a first case is superposed on a second case with a display section of the first case directed outward, in a folding rotary portable terminal in accordance with exemplary embodiment 3 of the present invention.

FIG. 6B is a plan view of the folding state where the first case is superposed on the second case with the display section of the first case directed outward, in the folding rotary portable terminal in accordance with exemplary embodiment 3.

FIG. 7A is an outward appearance of a folding state where a first case is superposed on a second case with a display section of the first case directed outward, in a folding rotary portable terminal in accordance with exemplary embodiment 4 of the present invention.

FIG. 7B is a plan view of the folding state where the first case is superposed on the second case with the display section of the first case directed outward, in the folding rotary portable terminal in accordance with exemplary embodiment 4.

FIG. 7C is a side view of a side face key in selecting touch input panel mode in accordance with exemplary embodiment 4.

### DETAILED DESCRIPTION OF PREFERRED EMBODIMENTS

Exemplary embodiments of the present invention will be described hereinafter with reference to the drawings.

A microphone for transmission, a speaker for reception, and an antenna are also, actually disposed on the surface and predetermined positions of a portable terminal, but they can have a general structure and hence are not illustrated or described.

### First Exemplary Embodiment

A folding rotary portable terminal in accordance with exemplary embodiment 1 of the present invention is described.

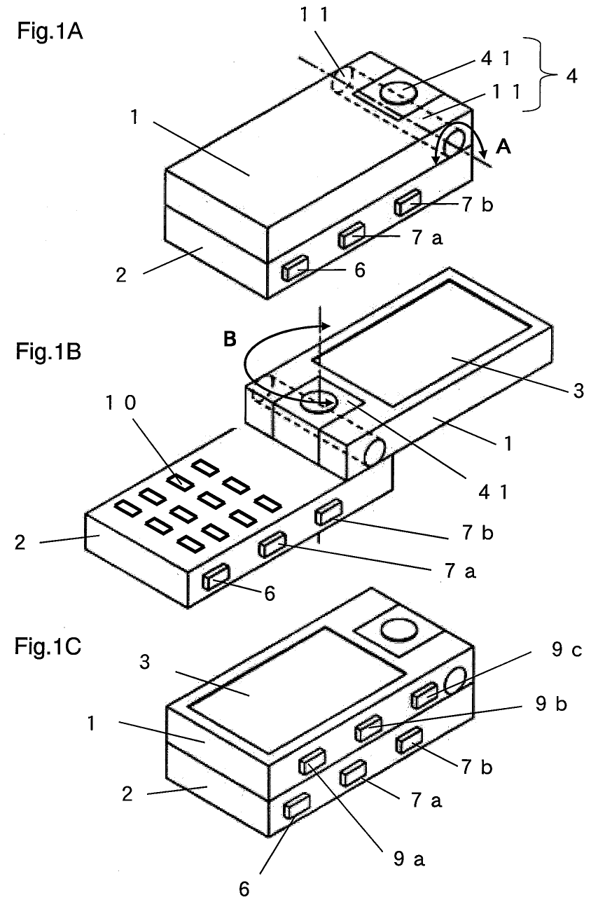

FIG. 1A through FIG. 1C are outward appearances of the folding rotary portable terminal in accordance with exemplary embodiment 1 of the present invention.

In FIG. 1A through FIG. 1C, first case 1 that has display section 3 for performing the information display or the like inside is coupled to second case 2 that has a camera section outside and operation section 10 inside through hinge part 4 having two degrees of freedom in rotation, namely the open/close direction and the orthogonal direction.

Hinge part 4 has a structure where a pair of support shafts 11 are projected outward in the direction orthogonal to rotary shaft 41 and first case 1 covers support shafts 11.

First case 1 opens or closes about the pair of support shafts 11 in the vertical direction (in the direction of arrow A) as shown in FIG. 1A, and rotates about rotary shaft 41 in the horizontal direction (in the direction of arrow B) as shown in FIG. 1B.

When the first case is rotated by 180° in the direction of arrow B from the state of FIG. 1B, a folding state where display section 3 of first case 1 is exposed to the outside is brought as shown in FIG. 1C.

Side face keys are arranged on different side faces of first case 1 and second case 2.

In other words, side face keys 9a, 9b and 9c are arranged on first case 1, and shutter key 6 and side face keys 7a and 7b are arranged on second case 2.

In the folding state of FIG. 1C, side face keys 9a, 9b and 9c of first case 1, and shutter key 6 and side face keys 7a and 7b of second case 2 are arranged on the same face. Since display section 3 is exposed and the camera section is disposed outside second case 2, various operations can be performed using shutter key 6 and side face keys 7a, 7b, 9a, 9b and 9c.

### Second Exemplary Embodiment

A folding rotary portable terminal in accordance with exemplary embodiment 2 of the present invention is described.

A folded state having a display section inside, an opened state of a first case, and a folding state having the display section that is exposed to the outside are described with reference to the drawings.

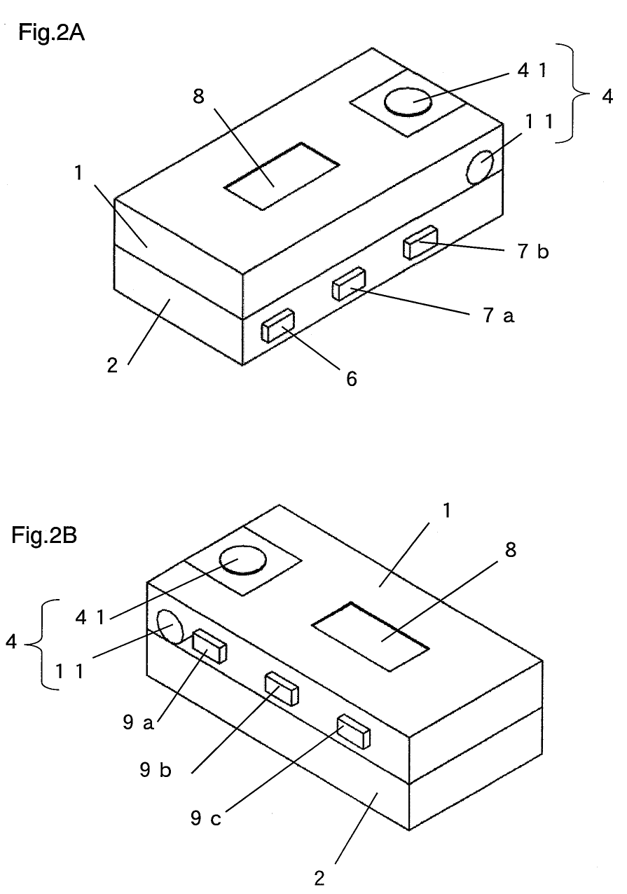

FIG. 2A and FIG. 2B are outward appearances of the folded state of the folding rotary portable terminal in accordance with exemplary embodiment 2 of the present invention.

The folding rotary portable terminal has the following elements:
first case 1 having a display section (not shown) inside and sub display section 8 outside;
second case 2 having a camera section outside; and
hinge part 4 having two degrees of freedom in rotation, namely opening or closing of first case 1 and second case 2 and rotation of them. Side face keys 9a, 9b and 9c are arranged on a side face of first case 1, and shutter key 6 and side face keys 7a and 7b are arranged on a side face of second case 2.

In FIG. 2A and FIG. 2B, a memo/manner mode switching function is assigned to side face key 7a, and a memo/manner mode setting function is assigned to side face key 7b. Thus, switch between the voice memo function and the manner mode function and setting of them can be easily performed even in the folded state.

In the folded state, a user can operate shutter key 6 and side face keys 7a and 7b of second case 2 with his/her right thumb, and can operate side face keys 9a, 9b and 9c of first case 1 with the forefinger and middle finger of his/her right or left hand.

When side face keys 9a, 9b and 9c are arranged on first case 1, the portable terminal is easily gripped, comparing with the structure where all of shutter key 6 and side face keys 9a, 9b and 9c are arranged on second case 2. Since the forefinger and middle finger are longer than the thumb, the side face keys are more easily pushed and the operability is more improved in the former structure than in the latter structure, in which all the side face keys are arranged on the same case.

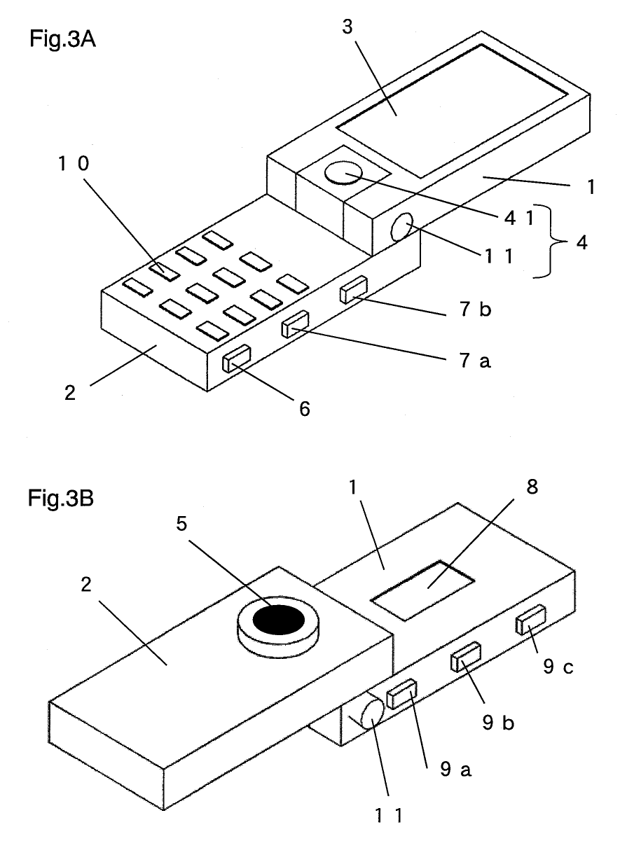

FIG. 3A and FIG. 3B are outward appearances of an opened state of the folding rotary portable terminal in accordance with exemplary embodiment 2.

FIG. 3A is an outward appearance showing a state where first case 1 is opened and display section 3 is directed upward. FIG. 3B is an outward appearance showing a state where first case 1 is opened and display section 3 is directed downward.

In FIG. 3A, side face keys 9a, 9b and 9c of first case 1 are arranged on the left side, and side face keys 7a and 7b of second case 2 are arranged on the right side.

Thanks to this structure, a user can operate side face keys 9a, 9b and 9c with his/her left thumb, and side face keys 7a and 7b with his/her right thumb. When the functions of various keys are assigned to respective side face keys, and are used as auxiliary keys of operation section 10, the operability can be further improved in using electronic mail or the Internet. Here, the various keys are a scroll up/down key, a scroll right/left key, a shift key and control key used in a personal computer, a clear key, and a decision key, for example.

Since side face keys of suitable size are arranged on different side faces in the folding rotary portable terminal of the present invention, two keys are not accidentally pushed even when a side face key is intended to be pushed with the thumb, and a certain operation is allowed.

In FIG. 3A and FIG. 3B, when the cases are held with both hands, the folding rotary portable terminal can be safely operated without being accidentally dropped.

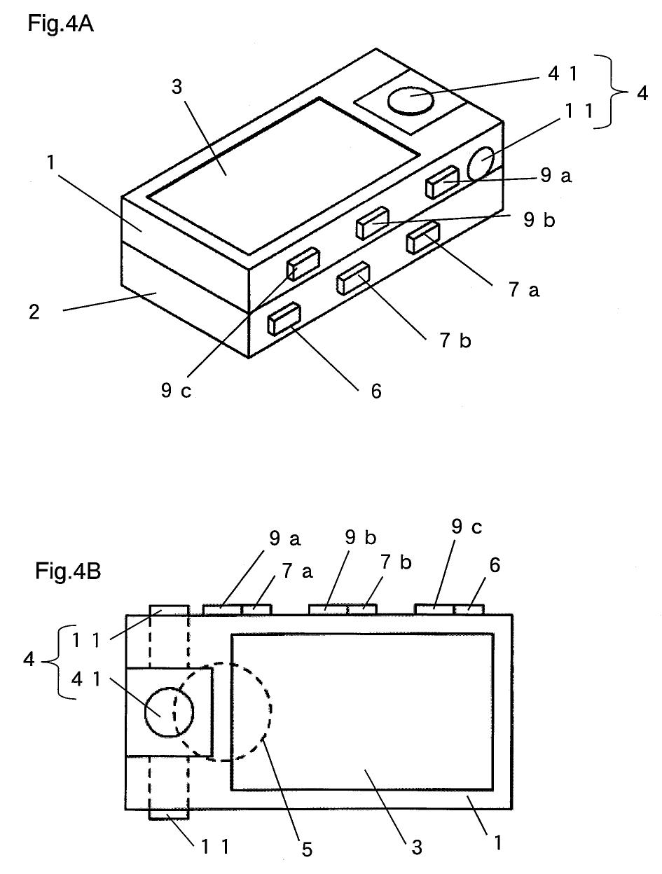

FIG. 4A and FIG. 4B are outward appearances of a folding state where display section 3 of first case 1 is rotated by 180° about rotary shaft 41 and is superposed on second case 2 while being directed outward, in the folding rotary portable terminal in accordance with exemplary embodiment 2 of the present invention.

In FIG. 4A and FIG. 4B, shutter key 6 and side face keys 7a and 7b on a side face of second case 2 and side face keys 9a, 9b and 9c on a side face of first case 1 are arranged alternately, namely by turns.

During photographing with camera, the user puts the cases of the folding state into a sideways position, tightly holds the downside of the cases with both thumbs, and operates side face keys 7a, 7b, 9a, 9b and 9c and shutter key 6 on the upper faces of the cases with his/her forefinger or the like.

Therefore, the user can safely photograph a subject without accidentally dropping the folding rotary portable terminal and without camera movement at the instant of photographing.

Further, the user can photograph a subject while monitoring display section 3 as a liquid crystal finder with a large screen, similarly to a usual standalone digital camera.

The types of all side face keys do not need to be same, a push type, a slide type, a seesaw type, or a jog dial type may be used depending on the mounted function and the inner structure of the cases.

The function of each side face key is also flexible. For example, a side face key may be assigned as an operation mode selection key. When the operation mode list is displayed on display section 3 and one operation mode to be operated is selected from a plurality of operation modes with the operation mode selection key in the folding state where display section 3 is directed outward, the function corresponding to the selected operation mode is assigned to each side face key, and the functions of respective side face keys are displayed on display section 3.

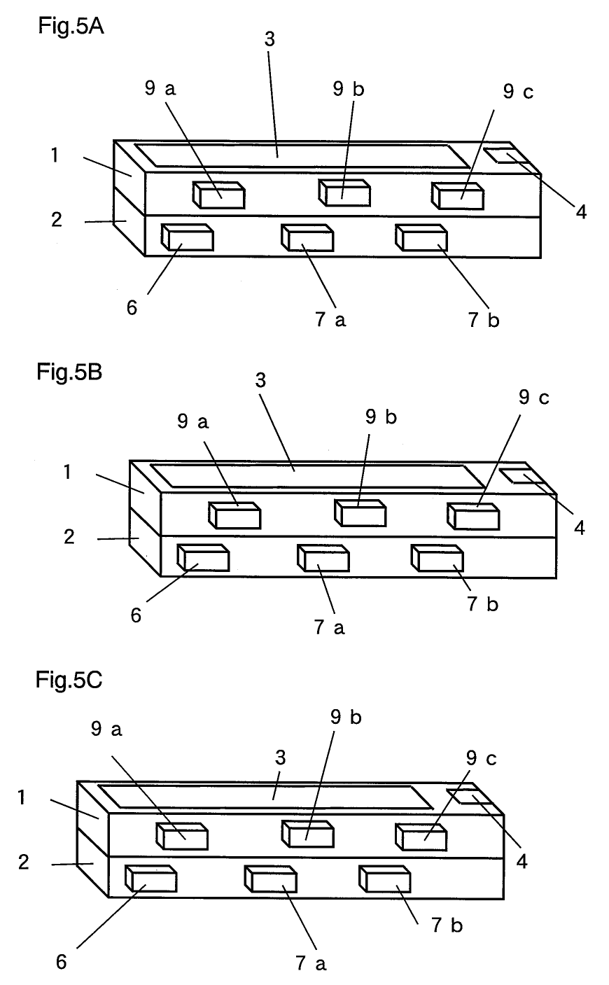

FIG. 5A through FIG. 5C are outward appearances of side face keys in examples where side face key 9a is assigned as an operation mode selection key and each operation mode is selected, in accordance with exemplary embodiment 2.

FIG. 5A is an outward appearance of the example where photographing mode is selected with operation mode selection key 9a in embodiment 2.

In FIG. 5A, side face key 7a of second case 2 is assigned as a zoom-in function key (zoom-in key), side face key 7b is assigned as a zoom-out function key (zoom-out key), and shutter key 6 is used as it is.

Side face key 9a of first case 1 is assigned as an operation mode selection key, side face key 9b is assigned as a macro switch key for switching the macro to close-up mode, and side face key 9c is assigned as a photo light key for switching the photo light between turn on and turn off. Side face keys 9b and 9c may be assigned to other functions such as a night mode key and a self timer.

Even when a plurality of side face keys are operated, the side face keys are assigned to two different side faces in this structure, so that operating error does not occur and many functions can be mastered.

Many side face keys can be arranged, so that the portable terminal can have an interface similar to that of a usual standalone digital camera and can be easily operated also by a user unskillful at operating it.

FIG. 5B is an outward appearance of the example where TV watching mode is selected with operation mode selection key 9a, in embodiment 2.

In FIG. 5B, side face key 7a of second case 2 is assigned as a minus shift key (channel minus key) for selecting a TV channel, and side face key 7b is assigned as a plus shift key (channel plus key) for selecting a TV channel. Side face key 9a of first case 1 is assigned as an operation mode selection key, side face key 9b is assigned as a sound volume minus key, and side face key 9c is assigned as a sound volume plus key.

Thanks to this structure, TV can be easily watched with one hand, alternate arrangement of the side face keys of different cases prevents two side face keys from being simultaneously pushed, and hence more certain operation is allowed.

Also when a user watches TV in a state where the case body is put into a sideways position to direct the side face keys upward, the user can easily operate the portable terminal with both hands.

FIG. 5C is an outward appearance of the example where navigation mode is selected with operation mode selection key 9a, in embodiment 2.

In FIG. 5C, side face key 7a of second case 2 is assigned as a scroll down key for scrolling down the display screen, and side face key 7b is assigned as a scroll up key for scrolling up the display screen. Side face key 9a of first case 1 is assigned as an operation mode selection key, side face key 9b is assigned as a scroll right key for scrolling the display screen right, and side face key 9c is assigned as a scroll left key for scrolling the display screen left.

Since all the side face keys are disposed on one side in this structure, the user can operate the portable terminal easily with one hand and hence can operate it while walking.

The portable terminal can be used similarly as a car navigation system.

### Third Exemplary Embodiment

A folding rotary portable terminal in accordance with exemplary embodiment 3 of the present invention is described.

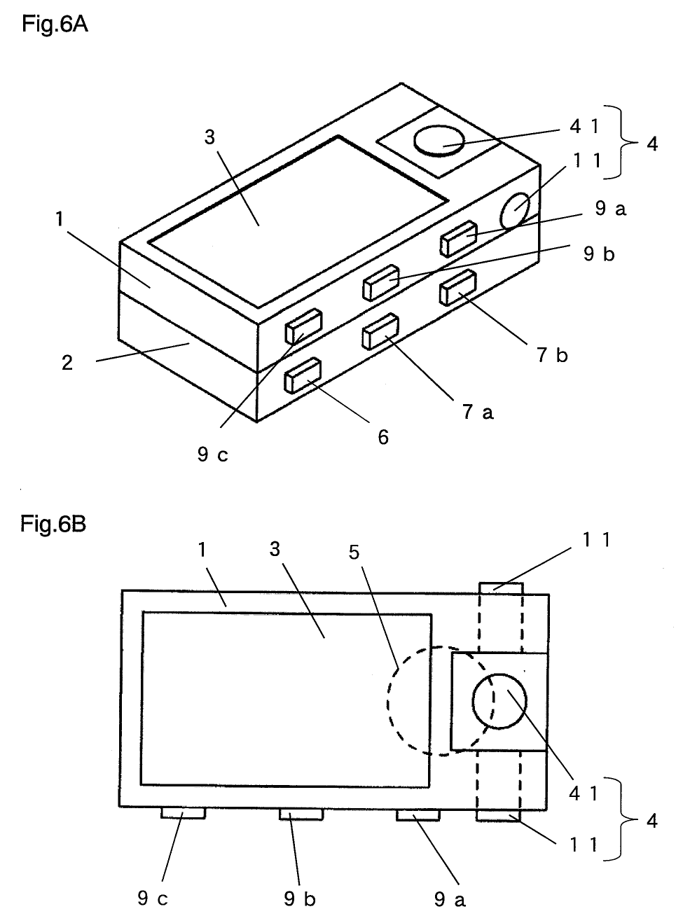

FIG. 6A and FIG. 6B are outward appearances of the folding rotary portable terminal in accordance with exemplary embodiment 3 of the present invention.

In FIG. 6A and FIG. 6B, elements similar to those in FIG. 1A through FIG. 1C, FIG. 4A, and FIG. 4B are denoted with the same reference marks, and the descriptions of those elements are omitted.

In the folding rotary portable terminal of FIG. 6A and FIG. 6B, side face key 9c overlaps with shutter key 6, side face key 9b overlaps with side face key 7a, side face key 9a overlaps with side face key 7b, in the folding state where first case 1 is superposed on second case 2 with display section 3 of first case 1 directed outward.

Thanks to this structure, two corresponding side face keys can be simultaneously pushed.

Therefore, when the number of mode types such as operation mode and selection mode is large and one side face key must be pushed at a plurality of times, the simultaneous push of two side face keys can reduce the number of operations or widen the variety of operations.

### Fourth Exemplary Embodiment

A folding rotary portable terminal in accordance with exemplary embodiment 4 of the present invention is described.

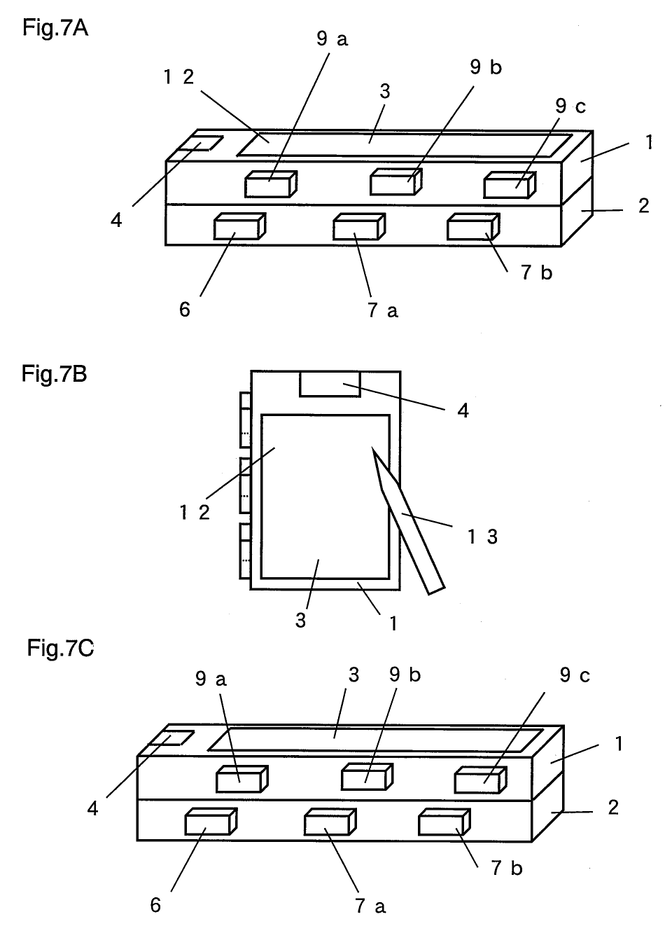

FIG. 7A through FIG. 7C are outward appearances of a folding state where first case 1 is superposed on second case 2 with display section 3 of first case 1 directed outward, in the folding rotary portable terminal in accordance with exemplary embodiment 4 of the present invention.

In FIG. 7A through FIG. 7C, elements similar to those in FIG. 1A through FIG. 1C, FIG. 4A, and FIG. 4B are denoted with the same reference marks, and the descriptions of those elements are omitted.

First case 1 of FIG. 7A defines input display section 12. Input display section 12 has a liquid crystal display panel and a transparent touch input panel disposed on the surface thereof. As shown in FIG. 7B, touch input on the screen of input display section 12 using input pen 13 is allowed.

Side face key 9a is assigned as an operation mode selection key, and operation mode is selected in the folding state where display section 3 is directed outward.

FIG. 7C is an outward appearance of the side face keys of the folding rotary portable terminal of FIG. 7A in the example where a touch input panel mode is selected with operation mode selection key 9a.

In FIG. 7C, side face key 7a is assigned as a scroll down key for scrolling down the display screen, and side face key 7b is assigned as a scroll up key for scrolling up the display screen, on the left surface (left surface in the opened state of both cases as shown in FIG. 1B) of second case 2.

Side face key 9a is assigned as the operation mode selection key, side face key 9b is assigned as clear key 9b for returning the display screen to the last state, and side face key 9c is assigned as a decision key of a function or the like, on the right surface (right surface in the opened state of both cases as shown in FIG. 1B) of first case 1.

Thanks to this structure, each side face key can be operated only with the left hand, and the operability is improved in using an electronic notepad function or an Internet function.

### INDUSTRIAL APPLICABILITY

In a folding rotary portable terminal of the present invention, the size of the display section can be made sufficiently large and the number of side face keys can be set larger. Therefore, the operations do not become complicated even in the folded state, and a multifunctional and compact folding rotary portable terminal is provided.

Especially, in the folding state where the first case is superposed on the second case with the display section of the first case directed outward, the camera or display section can be variously operated with one hand, and hence the folding rotary portable terminal is useful as a multimedia terminal having many functions.

In the opened state of the portable terminal, also, the operability is improved by using a side face key as an auxiliary key of the operation section. Therefore, the folding rotary portable terminal has high operability in any state.

### REFERENCE MARKS IN THE DRAWINGS

1 first case
2 second case
3 display section
4 hinge part
5 camera section
6 shutter key
7a, 7b, 7c, 9a, 9b, 9c side face keys 8 sub display section 10 operation section 11 support shaft 12 input display section 13 input pen 41 rotary shaft

1. A folding rotary portable terminal comprising:
a first case having a display section for at least displaying information;
a second case having at least a camera section; and
a hinge part having at least two degrees of freedom in rotation, namely an open/close direction and an orthogonal direction,
wherein
the first case is coupled to the second case through the hinge part, and
at least one side face key is disposed on different side faces of the first case and the second case.

2. A folding rotary portable terminal comprising:
a first case having a display section for at least displaying information;
a second case having at least a camera section; and
a hinge part having at least two degrees of freedom in rotation, namely an open/close direction and an orthogonal direction,
wherein
the first case is coupled to the second case through the hinge part, and
when the first case is rotated by 180° about a rotary shaft of the hinge part from an opened state to a folding state, side face keys arranged on the different side faces of the first case and the second case come to an identical side,
wherein, in the opened state, the first case and the second case are opened, and, in the folding state, the first case is superposed on the second case with the display section of the first case directed outward.

3. A folding rotary portable terminal comprising:
a first case having a display section for at least displaying information;
a second case having at least a camera section; and
a hinge part having at least two degrees of freedom in rotation, namely an open/close direction and an orthogonal direction,
wherein
the first case is coupled to the second case through the hinge part, and
when the first case is rotated by 180° about a rotary shaft of the hinge part from an opened state to a folding state, side face keys arranged on different side faces of the first case and the second case come to a top face, which has a shutter key,
wherein, in the opened state, the first case and the second case are opened, and, in the folding state, the first case is superposed on the second case with the display section of the first case directed outward.

4. The folding rotary portable terminal of one of claim 1 through claim 3,
wherein, when the first case is rotated by 180° about a rotary shaft of the hinge part from an opened state to a folding state, the side face keys arranged on the first case and the side face keys arranged on the second case come to alternate positions,
wherein, in the opened state, the first case and the second case are opened, and, in the folding state, the first case is superposed on the second case with the display section of the first case directed outward.

5. The folding rotary portable terminal of one of claim 1 through claim 3,
wherein when the first case is rotated by 180° about a rotary shaft of the hinge part from an opened state to a folding state, the side face keys arranged on the first case and the side face keys arranged on the second case overlap each other,
wherein, in the opened state, the first case and the second case are opened, and, in the folding state, the first case is superposed on the second case with the display section of the first case directed outward.

6. The folding rotary portable terminal of one of claim 1 through claim 3,
wherein a side face key of one of the two cases is an operation mode selection key and is used to select an operation mode to be operated from at least two operation modes.

7. The folding rotary portable terminal of one of claim 1 through claim 3,
wherein a side face key of one of the two cases is a shutter key.

8. The folding rotary portable terminal of one of claim 1 through claim 3,
wherein a side face key of one of the two cases is a zoom key.

9. The folding rotary portable terminal of one of claim 1 through claim 3,
wherein a side face key of one of the two cases is a photo light key.

10. The folding rotary portable terminal of one of claim 1 through claim 3,
wherein a side face key of one of the two cases is a macro switch key.

11. The folding rotary portable terminal of one of claim 1 through claim 3,
wherein a side face key of one of the two cases is a night mode switch key.

12. The folding rotary portable terminal of one of claim 1 through claim 3,
wherein a side face key of one of the two cases is a TV channel switch key.

13. The folding rotary portable terminal of one of claim 1 through claim 3,
wherein a side face key of one of the two cases is a key for scrolling up and down a screen of the display section, and a side face key of the other is a key for scrolling the screen of the display section left and right.

14. The folding rotary portable terminal of one of claim 1 through claim 3,
wherein a side face key of one of the two cases is a memo/manner mode switch key.

15. The folding rotary portable terminal of one of claim 1 through claim 3,
wherein a side face key of one of the two cases is a clear key.
